(19) United States
(12) Patent Application Publication
(10) Pub. No.: US 2006/0148618 A1
(43) Pub. Date: Jul. 6, 2006

(54) Vehicle stop-and-brake system

(76) Inventor: Tsao-Hui Huang, Banchiau City (TW)

Correspondence Address: Tsao-Hui Huang, P.O. Box 44-2049, TAIPEI, 10668, TW

(21) Appl. No.: 11/028,192

(22) Filed: Jan. 4, 2005

(51) Int. Cl. B60K 41/12

(52) U.S. Cl. 477/182

(57) ABSTRACT

The present invention relates to a vehicle stop-and-brake system having automatic and semi-automatic types, wherein the automatic type having a stop sensor, a drive unit, a connection system, a release switch, and an electronic control system and the semi-automatic type having a drive unit, a gearshift switch, a connection system, and an electronic control system.

### BACKGROUND OF THE INVENTION

(a) Field of the Invention

The present invention relates to a vehicle stop-and-brake system and more particularly for the vehicle stop-and-brake system delivering an electronic signal from a stop sensor or a gearshift switch to an electronic control system judging if the vehicle actually stops, which, after identifying a stop, then sends an electronic signal to a drive unit to activate a brake system through a connection system, thereby enabling the vehicle braked any time when stopping, which lessening the driver's effort in pressing a brake pedal or using a hand brake.

(b) Description of the Prior Art

Practice and defects of a conventional driver's mode can be as follows,
1. the hand brake is mostly used to prevent the vehicle from slipping when parking a vehicle and released when re-starting thereof, which is obviously not convenient for a frequent stop-and-start driver, such as a taxi driver or a deliverer.
2. the hand brake or the brake must be used on the occasion of the traffic jam or red traffic light, which is a tiring process to a driver.

### SUMMARY OF THE INVENTION

The present invention is a vehicle stop-and-brake system having a stop sensor, a drive unit, a gearshift switch, a connection system, a release switch, and an electronic control system, wherein the stop sensor formed on a transmission shaft delivering an electrical signal, when sensing a vehicle stop, to the electronic control system judging if a vehicle actually stops; the drive unit formed in a proper position activating braking; the gearshift switch formed in an automatic transmission vehicle delivering an electrical signal when shifting a gearshift level; the connection system connecting the drive unit and the brake system to actuate the brake system upon the drive unit being activated; the release switch formed on a gas pedal delivering an electronic signal to release braking upon pressing the gas pedal; and the electronic control system receiving signals from the stop sensor, the gearshift switch, and the release switch to control the drive unit to either activate or release braking.

The purpose of the present invention is to simplify an individual's driving activities by activating the brake system when stopping and releasing thereof when pressing the gas pedal, as in the automatic type, and by activating the brake system when the gearshift level shifting to N (neutral) or P (parking) position and releasing thereof when the gearshift level moving to D (forward) or R (reverse) position, as in the semi-automatic type.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a schematic representation of the present invention.

FIG. 2 shows a block diagram of how a brake system works for the automatic type of the present invention.

FIG. 3 shows a block diagram of how a brake system releases for the automatic type of the present invention.

FIG. 4 shows a block diagram of how a brake system works for the semi-automatic type of the present invention.

FIG. 5 shows a block diagram of how a brake system releases for the semi-automatic type of the present invention.

### DETAILED DESCRIPTION OF THE PREFERRED EMBODIMENTS

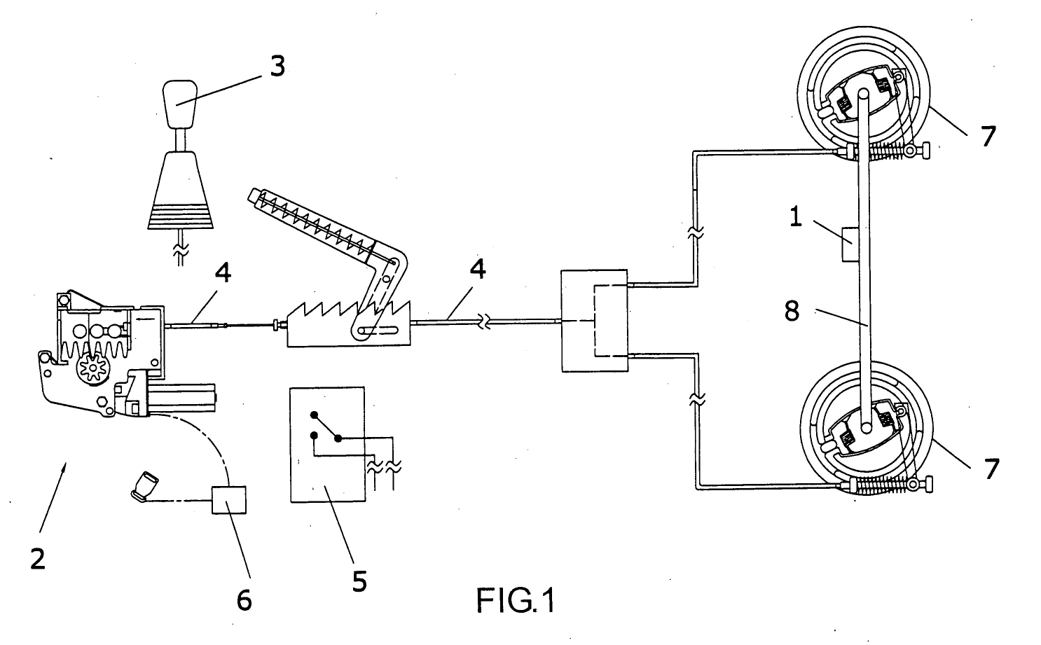

Referring to FIG. 1. The present invention relates to a vehicle stop-and-brake system having automatic and semi-automatic types and including a stop sensor 1, a drive unit 2, a gearshift switch 3, a connection system 4, a release switch 5, and an electronic control system 6, wherein
the stop sensor 1 formed on a transmission shaft 8 delivering an electrical signal (positive voltage), when sensing a vehicle stop, to the electronic control system 6 for judging if a vehicle actually stops;
the drive unit 2, such as a motor, formed in a proper position activating the brake system;
the gearshift switch 3 formed on a gearshift level of an automatic transmission vehicle delivering an electrical signal (positive voltage) when the gearshift switch 3 at N (neutral) or P (parking) position;
the connection system 4, being a steel cable or a chain, connecting the drive unit 2 and a brake system 7 to actuate the brake system 7 upon the drive unit 2 being activated;
the release switch 5, being applied to the automatic type, formed on a gas pedal of a manual transmission vehicle for delivering an electronic signal (positive voltage) to release braking upon pressing a gas pedal;
the electronic control system 6 having electronic circuits thereon and receiving signals from the stop sensor 1, the gearshift switch 3, and the release switch 5 for controlling the drive unit 2 to either activate or release braking.

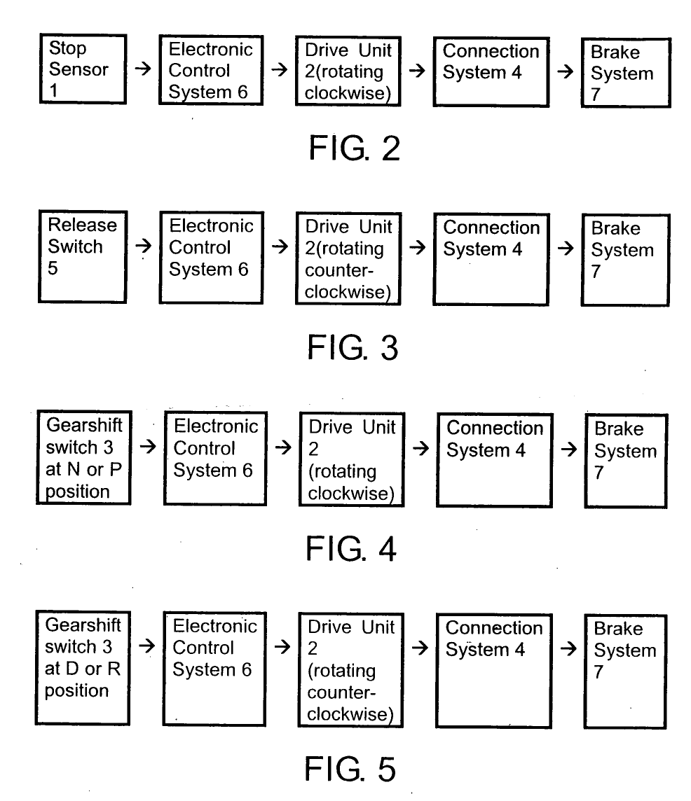

Referring to FIGS. 2 and 3. For the automatic type applying to either an automatic or a manual transmission vehicle, the stop sensor 1 on the transmission shaft 8 outputs a electronic signal, when sensing a vehicle stop, to the electronic control system 6, which then delivers an electronic signal to the drive unit 2 rotating clockwise to activate the brake system 7 through the connection system 4. On the contrary, upon pressing the gas pedal, the release switch 5 thereon will be activated delivering an electronic signal to the electronic control system 6, which then sends an electronic signal to the drive unit 2 rotating counterclockwise to release the brake system 7 through the connection system 4, thereby enabling the brake being actuated when stopping the vehicle and being released when pressing the gas pedal.

Referring to FIGS. 4 and 5. For the semi-automatic type applying only to an automatic transmission vehicle, the gearshift switch 3 delivers an electronic signal, when having the gearshift level at N (neutral) or P (parking) position, to the electronic control system 6, which then sends an electronic signal to the drive unit 2 rotating clockwise to activate the brake system 7 through the connection system 4. On the contrary, upon the gearshift level moving to D (forward) or R (reverse) position, the gearshift switch 3 sends an electronic signal to the electronic control system 6, which then delivers an electronic signal to the drive unit 2 rotating counterclockwise to release the brake system 7 through the connection system 4, thereby enabling the brake being actuated when having the gearshift switch at N or P position and being released when having the gearshift switch at D or R position.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A vehicle stop-and-brake system being divided into automatic and semi-automatic types and comprising a stop sensor, a drive unit, a gearshift switch, a connection system, a release switch, and an electronic control system, wherein
the stop sensor formed on a transmission shaft delivering an electrical signal, when sensing a vehicle stop, to the electronic control system for judging if a vehicle's stop;
the drive unit, such as a motor, formed in a proper position to activate braking;
the gearshift switch formed in an automatic transmission vehicle delivering an electrical signal when shifting a gearshift level;
the connection system, being a steel cable or a chain, connecting the drive unit and the brake system to actuate the brake system upon activating the drive unit;
the release switch, being applied to a automatic type, formed on a gas pedal for delivering an electronic signal to release braking upon pressing the gas pedal;
the electronic control system, receiving electronic signals from the stop sensor, the gearshift switch, and the release switch for controlling the drive unit to either activate or release braking.

2. The vehicle stop-and-brake system as recited in claim 1, wherein the gearshift switch formed on the gearshift level.

3. The vehicle stop-and-brake system as recited in claim 1, wherein for the automatic type applying to either an automatic or a manual transmission vehicle,
upon sensing a vehicle stop, the stop sensor on the transmission shaft outputting an electronic signal to the electronic control system, which, after identifying a stop, delivering an electronic signal to the drive unit to activate the brake system through the connection system;
upon pressing the gas pedal, the release switch on the gas pedal being activated to deliver an electronic signal to the electronic control system, which then delivering an electronic signal to the drive unit to release the brake system through the connection system.

4. The vehicle stop-and-brake system as recited in claim 1, wherein for the semi-automatic type applying only to an automatic transmission vehicle,
upon shifting the gearshift level to N (neutral) or P (parking) position, the gearshift switch being activated and delivering an electronic signal to the electronic control system, which then delivering an electronic signal to the drive unit to activate the brake system through the connection system;
upon moving the gearshift level to D (forward) or R (reverse) position, the gearshift switch being activated, sending an electronic signal to the electronic control system, which then delivering an electronic signal to the drive unit to release the brake system through the connection system.
